(19) United States
(12) Patent Application Publication
(10) Pub. No.: US 2018/0177664 A1
(43) Pub. Date: Jun. 28, 2018

(54) MOTION ASSISTANCE APPARATUS

(71) Applicant: Samsung Electronics Co., Ltd., Suwon-si (KR)

(72) Inventors: Hyun Do CHOI, Yongin-si (KR); Youngjin Park, Seoul (KR); Se-Gon Roh, Suwon-si (KR); Minhyung Lee, Seoul (KR); Jongwon Lee, Suwon-si (KR); Byungjune Choi, Gunpo-si (KR); Jungyun Choi, Seoul (KR)

(73) Assignee: Samsung Electronics Co.,Ltd., Suwon-si (KR)

(21) Appl. No.: 15/797,402

(22) Filed: Oct. 30, 2017

(30) Foreign Application Priority Data
Dec. 27, 2016 (KR) 10-2016-0180283

(51) Int. Cl. A61H 1/02; A63B 23/10

(52) U.S. Cl. CPC A61H 1/0259; A63B 23/10; A61H 3/008; A61H 1/0266; A61H 1/0262

(57) ABSTRACT

A motion assistance apparatus including a proximal support configured to support a proximal part of a user, a distal support configured to support a distal part of the user, a rotating frame configured to connect to the distal support and simultaneously perform a translation and a rotation relative to the proximal support, a driving source configured to generate a rotational power, and a speed reducer configured to convert the rotational power generated from the driving source to a translational power and transfer the translational power to the rotating frame may be provided.

### CROSS-REFERENCE TO RELATED APPLICATION

This application claims priority under 35 U.S.C. § 119 to Korean Patent Application No. 10-2016-0180283, filed on Dec. 27, 2016 in the Korean Intellectual Property Office, the entire contents of which are incorporated herein by reference.

### BACKGROUND

### 1. Field

At least one example embodiment relates to motion assistance apparatus.

### 2. Description of the Related Art

Motion assistance apparatuses that enable the elderly and/or patients having joint issues to walk with less effort and apparatuses for assisting the muscular strength of the users, for instance, for military purposes are being developed.

### SUMMARY

Some example embodiments relate to motion assistance apparatuses.

In some example embodiment, the motion assistance apparatus may include a proximal support configured to support a proximal part of a user, a distal support configured to support a distal part of the user, a rotating frame configured to connect to the distal support and simultaneously or concurrently perform a translation and a rotation relative to the proximal support, a driving source configured to generate a rotational power, and a speed reducer configured to convert the rotational power generated from the driving source to a translational power, and transfer the translational power to the rotating frame.

The proximal support may be configured to support a calf of the user and the distal support is configured to support a foot of the user, and the rotating frame may be in front of and above an ankle of the user in a state in which the motion assistance apparatus is worn by the user.

The proximal support may be configured to support a calf of the user and the distal support may be configured to support a foot of the user, and a portion of the rotating frame that may be connected to the distal support be provided between an ankle and a forefoot of the user in a state in which the motion assistance apparatus is worn by the user.

The motion assistance apparatus may further include a power distributor including a power transmission member, a first output terminal, and a second output terminal, the first output terminal and the second output terminal connected to the rotating frame and having different translation speeds relative to each other, the power transmission member configured to connect to the speed reducer and the rotating frame.

The power distributor may further include a connecting member configured to connect the first output terminal and the second output terminal, and configured to rotatably connect to the proximal support.

The second output terminal may include a load body, a first joint provided at a first end of the load body and configured to rotatably connect to the connecting member with at least 2 degrees of freedom (DOF), and a second joint provided at a second end of the load body and configured to rotatably connect to the rotating frame with at least 2 DOF.

In response to driving the power distributor, the first output terminal may be configured to perform the translation relative to the proximal part, and the second output terminal may be configured to perform the translation relative to the first output terminal.

The connecting member may include a single pair of parallel links each configured to connect the first output terminal and the second output terminal.

The rotating frame may include a base link configured to rotate in a yaw direction relative to a first output terminal.

The base link may be connected to the first output terminal and configured to rotate about a rotation shaft extending forward and upward from an ankle of the user, and receive a movement occurring in response to a foot of the user performing an eversion and inversion motion based on a subtalar joint of the user.

The rotating frame may include a support link configured to connect to the distal support and rotate in a pitch direction relative to the base link.

Other example embodiments relate to motion assistance apparatuses.

In some example embodiments, the motion assistance apparatus may include a proximal support to be placed below a knee of a user, a distal support to be placed at a foot of the user, a rotating frame provided between the proximal support and the distal support, the rotating frame configured to move with 2 DOF, receive a movement occurring in response to the foot performing a dorsi-and-plantar-flexion motion based on an talocrural joint of the user, and perform an eversion and inversion motion based on a subtalar joint of the user, a pressure sensor at the distal support and configured to measure a pressure of a distal part of the user against the distal support, and a controller configured to control a driving source based on information measured at the pressure sensor.

The pressure sensor may include a first sensor configured to sense a pressure of a first part of the foot of the user, and a second sensor configured to sense a pressure of a second part of the foot of the user.

The first sensor may be provided at a location at which a heel of the user is to be placed in the distal support, and the second sensor may be provided at a location at which a metatarsal bone of the user is to be placed in the distal support.

The controller may be configured to classify a walking state of the user into a plurality of phases based on sensing signals of the first sensor and the second sensor, and control the driving source based on a control signal corresponding to each of the phases.

The motion assistance apparatus may further include a third sensor configured to measure an angle of the talocrural joint of the user, wherein the controller may be configured to classify the walking state of the user into a weight load phase in a case that a pressure is sensed at the first sensor and is not sensed at the second sensor, an intermediate phase in a case that the pressure is sensed at the first sensor and the second sensor, a terminal phase in a case that the pressure is not sensed at the first sensor and is sensed at the second sensor, and a swing phase in a case that the pressure is not sensed at the first sensor and the second sensor.

In the weight load phase, the driving source may be configured to supply a power in proportion to an angular velocity of the talocrural joint.

In the intermediate phase, the driving source may be configured to supply a power based on a difference between the angle of the talocrural joint and a first setting angle and an angular velocity of the talocrural joint.

In the terminal phase, the driving source may be configured to supply a power based on the angle of the talocrural joint.

In the swing phase, the driving source may be configured to supply a power based on a difference between the angle of the talocrural joint and a second setting angle and an angular velocity of the talocrural joint.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIG. 1A illustrates a motion of a talocrural joint of a user according to at least one example embodiment;

FIG. 1B illustrates a motion of a subtalar joint of a user according to at least one example embodiment;

FIG. 2 is a perspective view of a motion assistance apparatus according to at least one example embodiment;

FIG. 3 illustrates a second output terminal according to at least one example embodiment;

FIG. 4 illustrates a power transmission member according to at least one example embodiment;

FIG. 5 is a front view of a power distributor according to at least one example embodiment when a talocrural joint of a user is in a dorsi-flexion state;

FIG. 6 is a side view of a motion assistance apparatus according to at least one example embodiment when a talocrural joint of a user is in a dorsi-flexion state;

FIG. 7 is a front view of a power distributor according to at least one example embodiment when a talocrural joint of a user is in a plantar-flexion state;

FIG. 8 is a side view of a motion assistance apparatus according to at least one example embodiment when a talocrural joint of a user is in a plantar-flexion state;

FIG. 9A illustrates an eversion motion of an ankle of a user;

FIG. 9B illustrates an inversion motion of an ankle of a user;

FIG. 10 is a partially enlarged view of a rotating frame according to at least one example embodiment;

FIG. 11 is a front view of a motion assistance apparatus according to at least one example embodiment in an eversion state;

FIG. 12 is a front view of a motion assistance apparatus according to at least one example embodiment;

FIG. 13 is a side view of a motion assistance apparatus according to at least one example embodiment;

FIG. 14 is a block diagram illustrating a motion assistance apparatus according to at least one example embodiment; and

FIG. 15 is a flowchart illustrating a controlling method of a motion assistance apparatus according to at least one example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of the example embodiments, detailed description of well-known related structures or functions will be omitted.

It should be understood, however, that there is no intent to limit this disclosure to the particular example embodiments disclosed. On the contrary, the example embodiments are to cover all modifications, equivalents, and alternatives falling within the scope of example embodiments. Like numbers refer to like elements throughout the description of the figures.

In addition, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected”, “coupled”, or “joined” to another component, a third component may be “connected”, “coupled”, and “joined” between the first and second components, although the first component may be directly connected, coupled or joined to the second component.

The terminology used herein is for the purpose of describing particular example embodiments only and is not intended to be limiting. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Various example embodiments will now be described more fully with reference to the accompanying drawings in which some example embodiments are shown. In the drawings, the thicknesses of layers and regions are exaggerated for clarity.

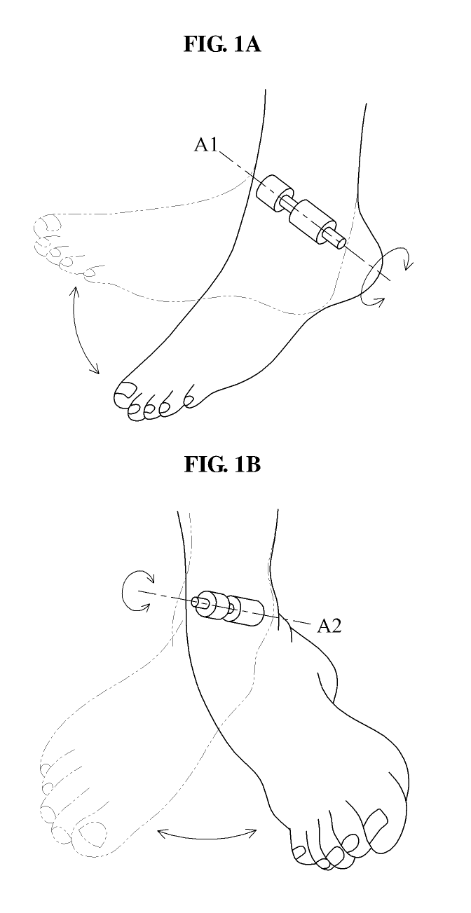

FIG. 1A illustrates a motion of a talocrural joint of a user according to at least one example embodiment, and FIG. 1B illustrates a motion of a subtalar joint of a user according to at least one example embodiment.

Referring to FIGS. 1A and 1B, an ankle of the user may move about two shafts. A first shaft A1 and a second shaft A2 conceptually illustrate the talocrural joint and the subtalar joint, respectively. The ankle of the user may perform a dorsi-flexion motion or a plantar-flexion motion about the talocrural joint. Further, the ankle of the user may perform an eversion motion or an inversion motion about the subtalar joint. In response to a movement of the ankle about one of the first shaft A1 and the second shaft A2, a location or an angle of the other shaft may vary. Hereinafter, the example embodiments will be described based on an example in which the motion assistance apparatus enables a movement of an ankle about the first shaft A1 and/or the second shaft A2.

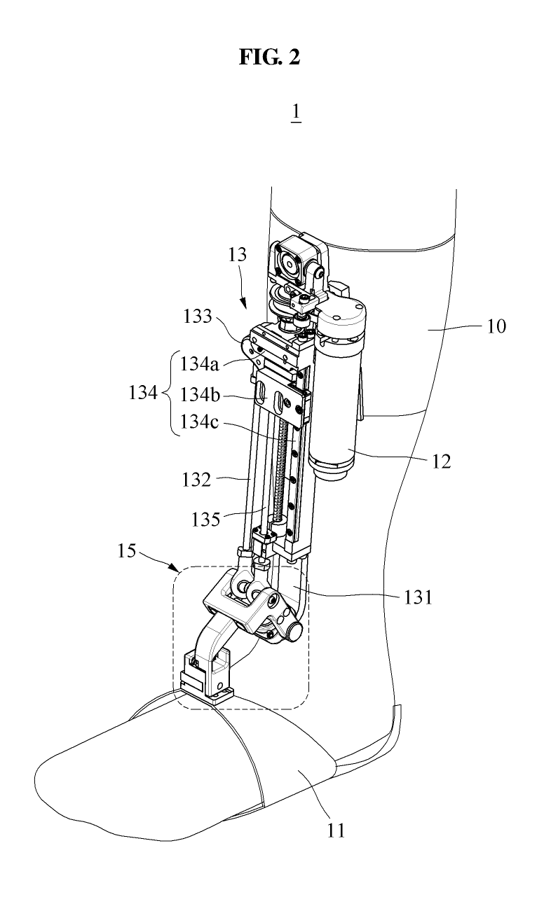

FIG. 2 is a perspective view of a motion assistance apparatus according to at least one example embodiment.

Referring to FIG. 2, a motion assistance apparatus 1 according to at least one example embodiment may be worn by a user and assist a motion of the user. The user may be, for example, a human, an animal, or a robot, but is not limited thereto. The motion assistance apparatus 1 may include a proximal support 10, a distal support 11, a driving source 12, a power distributor 13, and a rotating frame 15.

The proximal support 10 and the distal support 11 may face each other with respect to a joint of the user, and may support a proximal part and a distal part, respectively. The proximal support 10 and the distal support 11 may face each other with respect to an ankle of the user. The proximal support 10 may support a part below a knee (e.g., a calf), and the distal support 11 may support a part below the ankle (e.g., a foot). In some example embodiment, the proximal support 10 may include a detachable belt, which is configured to support the overall circumference of the calf of the user, and the distal support 11 may have a structure surrounding the overall top and sole of the foot to support the foot of the user.

Although FIG. 2 illustrates an example in which the motion assistance apparatus 1 assists a motion of the ankle of the user, the motion assistance apparatus 1 may assist another part of an upper body of the user (e.g., a wrist, an elbow, and/or a shoulder) of the user, or another part of a lower body of the user (e.g., a knee and/or a hip joint) of the user. That is, the motion assistance apparatus 1 may assist a motion of a part of the user. Hereinafter, an example in which the motion assistance apparatus 1 assists the motion of the ankle of the user will be described.

The driving source 12 may generate a power for driving the power distributor 13. The driving source 12 may be, for example, a motor for generating a rotational power. As another example, the driving source 12 may use a piston-cylinder method or a wire driving method for generating a translation power. Hereinafter, an example in which a motor is used for the driving source 12 will be described.

The power distributor 13 may include a speed reducer 134 configured to decelerate the power transferred from the driving source 12, a power transmission member 135 configured to transfer the power from the speed reducer 134 to the rotating frame 15, a first output terminal 131 and a second output terminal 132 configured to be supplied with the power generated at the driving source 12 and to be driven with the supplied power, and a connecting member 133 configured to connect the first output terminal 131 and the second output terminal 132 so that one of the first output terminal 131 and the second output terminal 132 moves relative to the other one.

The speed reducer 134 may include a transmission mechanism configured to convert a rotation to a translation using a ball screw. The speed reducer 134 may include a bolt portion 134a configured to receive the rotation from the driving source 12, a nut portion 134b configured to couple with the bolt portion 134a and perform a translation along a longitudinal direction of the bolt portion 134a in response to rotating of the bolt portion 134a, and a guide portion 134c configured to guide the nut portion 134b to vertically slide. As another example, the speed reducer 134 may include a transmission mechanism (e.g., a motion pulley), which is configured to decelerate and transfer a translation without converting the translation to another type. Here, a type of the speed reducer 134 is not limited. Hereinafter, an example in which the speed reducer 134 uses the ball screw method will be described.

The power transmission member 135 may connect the speed reducer 134 and the rotating frame 15. The power transmission member 135 may be a rod configured to transfer the translation of the speed reducer 134 to the rotating frame 15. The power transmission member 135 may translate or rotate the rotating frame 15 with the power transferred from the speed reducer 134.

The first output terminal 131 and the second output terminal 132 may move in the same direction at different speeds by way of the connecting member 133, in response to an operation of the power distributor 13. The speed of the second output terminal 132 may be greater than that of the first output terminal 131. The connecting member 133 may be rotatably connected to each of the first output terminal 131 and the second output terminal 132. According to the above structure, two output terminals may move relatively with respect to each other. For example, the connecting member 133 may be a longitudinal member of which one side is rotatably fixed to the proximal support 10 surrounding a part below the knee (e.g., the calf). According to the above structure, the first output terminal 131 may move relative to the proximal support 10 in a vertical direction that connects the knee and the ankle. Likewise, the second output terminal 132 may move relative to the first output terminal 131 in an approximately vertical direction.

The rotating frame 15 may simultaneously or concurrently perform the translation and the rotation with respect to the proximal support 10. A first part of the rotating frame 15 may be connected to the distal support 11 that surrounds the top and the sole of the foot in front of the ankle, a second part of the rotating frame 15 may be connected to the speed reducer 134 through the power transmission member 135, a third part of the rotating frame 15 may be connected to the second output terminal 132, and a fourth part of the rotating frame 15 may be rotatably connected to the first output terminal 131. According to the above structure, the rotating frame 15 may rotate by using the proximity of the talocrural joint of the user as a remote center of motion (RCM) without being connected to a configuration positioned on a shaft of the talocrural joint of the user. Accordingly, the rotating frame 15 may exhibit a movement similar to an actual motion of the talocrural joint of the user.

Moving parts including the power distributor 13 and the rotating frame 15 may be provided in front of the lower leg of the user between the ankle of the user and the forefoot of the user based on a state in which the motion assistance apparatus 1 is worn by the user. For example, all of the moving parts may be positioned between the foot and the knee of the user in the vertical direction. According to the above structure, the motion assistance apparatus 1 may be mounted to the user without having any moving parts at the rear of a lower leg of the user. Thus, once the moving parts are provided in front of the lower leg of the user, the user may put on or take off shoes while wearing the motion assistance apparatus 1. Accordingly, user convenience may be enhanced.

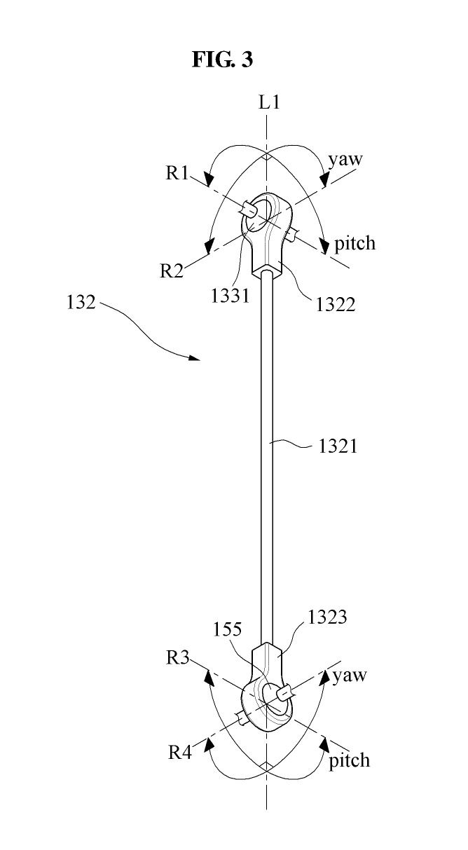

FIG. 3 illustrates a second output terminal according to at least one example embodiment.

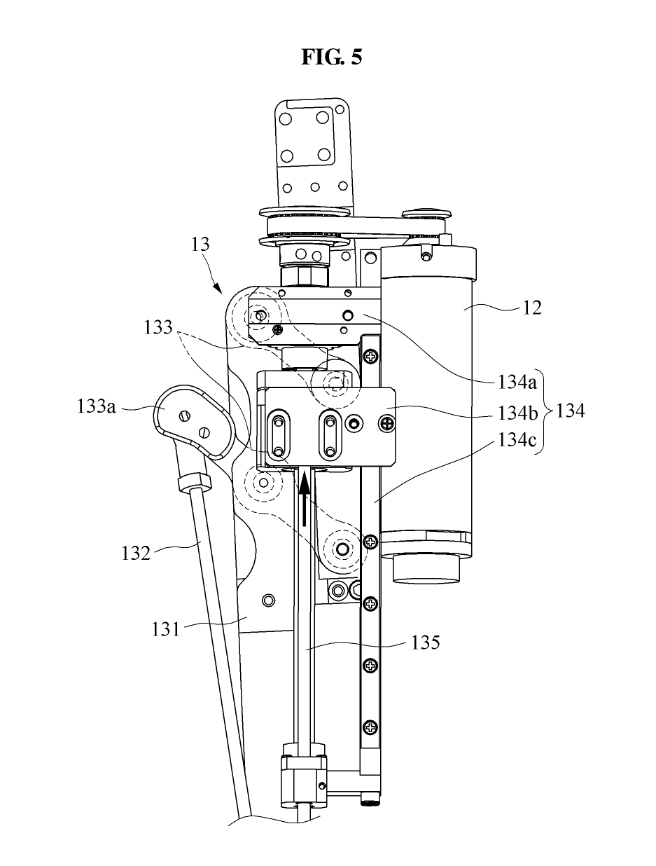

Referring to FIG. 3, the second output terminal 132 may include a rod body 1321, and a first joint 1322 and a second joint 1323 that are provided at both ends of the rod body 1321, respectively. The first joint 1322 may be pivotally connected to the connecting member 133 with at least 2 degrees of freedom (DOF), and the second joint 1323 may be pivotally connected to the rotating frame 15 with at least 2 DOF. For example, the connecting member 133 may include a protrusion 133a (see FIG. 5) and a first connector 1331. The first joint 1322 may be connected to the first connector 1331 and may be rotatable with at least 2 rotational DOF. The 2 rotational DOF may include a yaw rotational DOF indicating a rotation about a first rotating shaft R1 that is perpendicular in a forward-and-backward direction relative to a longitudinal shaft L1 of the rod body 1321 and a pitch rotational DOF indicating a rotation about a second rotating shaft R2 that is perpendicular in a left-and-right direction relative to the longitudinal shaft L1 of the rod body 1321. Referring to FIG. 3, if the first connector 1331 is a ball bearing or a ball joint, the first joint 1322 may roll-rotate about the longitudinal shaft L1 of the rod body 1321. Thus, the first joint 1322 may rotate with 3 rotational DOF including the yaw rotational DOF, the pitch rotational DOF, and the roll rotational DOF.

The rotating frame 15 may include a second connector 155, and the second joint 1323 may be connected to the second connector 155 and may rotate with at least 2 rotational DOF. The 2 rotational DOF may include a yaw rotational DOF indicating a rotation about a third rotating shaft R3 that is perpendicular in a forward-and-backward direction relative to the longitudinal shaft L1 of the rod body 1321 and a pitch rotational DOF indicating a rotation about a fourth rotating shaft R4 that is perpendicular in a left-and-right direction relative to the longitudinal shaft L1 of the rod body 1321. Referring to FIG. 3, if the second connector 155 is a bearing ball or a ball joint, the second joint 1323 may roll-rotate about the longitudinal shaft L1 of the rod body 1321. Thus, the second connector 155 may rotate with 3 rotational DOF including the yaw rotational DOF, the pitch rotational DOF, and the roll rotational DOF.

The first joint 1322 may be pitch-rotatably connected to the protrusion 133a, and the second joint 1323 may be pitch-rotatably connected to the rotating frame 15. According to the above structure, in response to an occurrence of a speed difference between the first output terminal 131 and the protrusion 133a, the rod body 1321 may pitch-rotate relative to the first output terminal 131 and may make the second joint 1323 move forward or backward relative to the first output terminal 131. That is, the rotating frame 15 connected to the second joint 1323 may pitch-rotate relative to the first output terminal 131 such that the talocrural joint of the user performs a dorsi-flexion or a plantar-flexion.

The first joint 1322 may be yaw-rotatably connected to the connecting member 133, and the second joint 1323 may be yaw-rotatably connected to the rotating frame 15. According to the above structure, although the rotating frame 15 yaw-rotates relative to the first output terminal 131 in response to the user performing an eversion motion or an inversion motion along the rotating shaft of the subtalar joint, torque may be prevented from being applied to the second output terminal 132. Accordingly, the user may conveniently perform the eversion motion or the inversion motion without an external force generated by the second output terminal 132. That is, the second output terminal 132 may operate to adapt to a movement of the subtalar joint of the user.

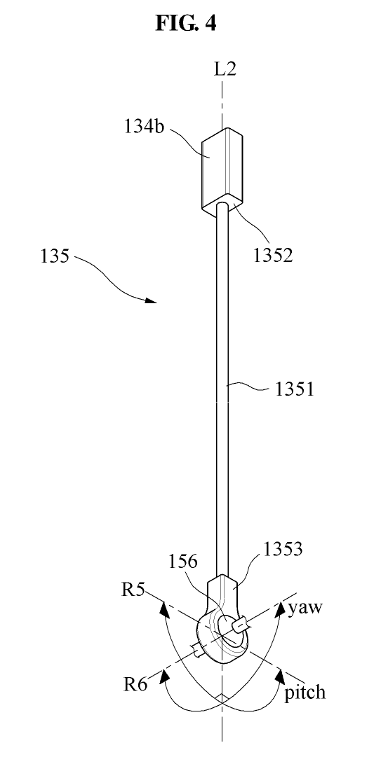

FIG. 4 illustrates a power transmission member according to at least one example embodiment.

Referring to FIG. 4, the power transmission member 135 may include a member body 1351 and a first end 1352 and a second end 1353 that are provided at both ends of the member body 1351, respectively. The first end 1352 may be connected to the nut portion 134b of the speed reducer 134 and may perform a translation integrally with the nut portion 134b. The second end 1353 may be pivotally connected to the rotating frame 15 with at least 2 rotational DOF. For example, the rotating frame 15 may include a third connector 156, and the second end 1353 may be connected to the third connector 156 and may rotate with at least 2 rotational DOF. The 2 rotational DOF may include a yaw rotational DOF indicating a rotation based on a fifth rotating shaft R5 that is perpendicular in a forward-and-backward direction relative to a longitudinal shaft L2 of the member body 1351 and a pitch rotational DOF indicating a rotation based on a sixth rotating shaft R6 that is perpendicular in a left-and-right direction relative to the longitudinal shaft L2 of the member body 1351. Referring to FIG. 4, if the third connector 156 is a ball bearing or a ball joint, the second end 1353 may roll-rotate about the longitudinal shaft L2 of the member body 1351. Thus, the third connector 156 may rotate with 3 rotational DOF including the yaw rotational DOF, the pitch rotational DOF, and the roll rotational DOF.

The second end 1353 may be pitch-rotatably connected to the rotating frame 15. The above structure may embody the talocrural joint of the user to perform a dorsi-flexion or a plantar-flexion in response to an occurrence of difference in a vertical speed between the first output terminal 131 and the protrusion 133a.

The second end 1353 may be yaw-rotatably connected to the rotating frame 15. According to the above structure, although the rotating frame 15 yaw-rotates relative to the first output terminal 131 in response to the user performing an eversion motion or an inversion motion along the rotating shaft of the subtalar joint, torque may be prevented from being applied to the power transmission member 135. Accordingly, the user may conveniently perform the eversion motion or the inversion motion without an external force from the power transmission member 135. That is, the power transmission member 135 may operate to adapt to a movement of the subtalar joint of the user.

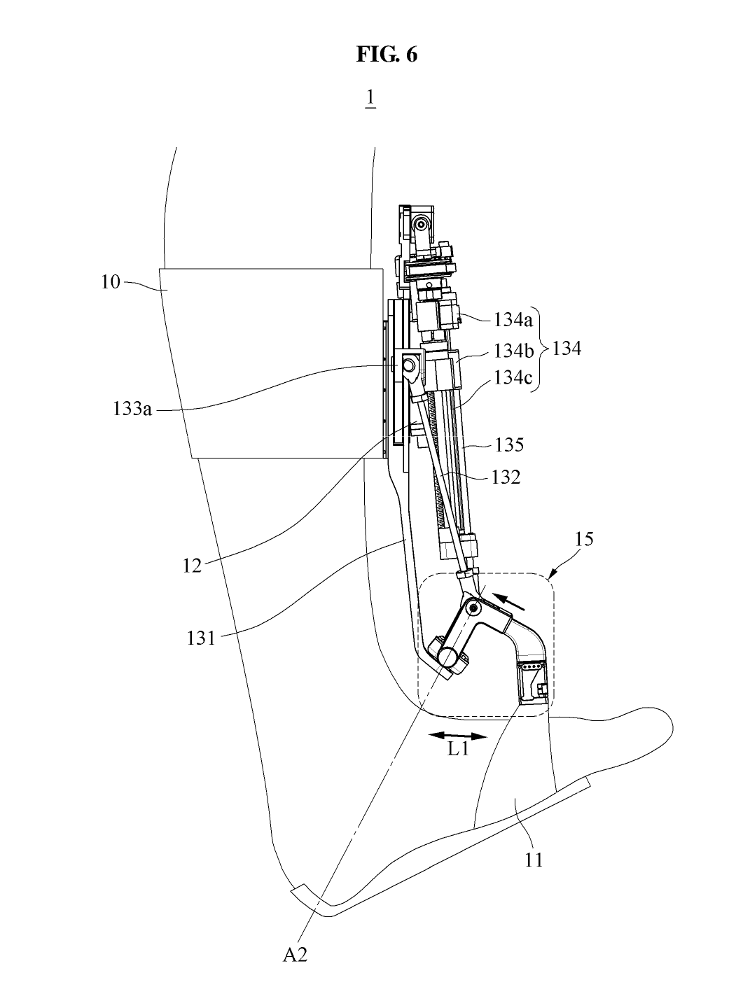

FIG. 5 is a front view of a power distributor according to at least one example embodiment when a talocrural joint of a user is in a dorsi-flexion state. FIG. 6 is a side view of a motion assistance apparatus according to at least one example embodiment when a talocrural joint of a user is in a dorsi-flexion state.

Referring to FIGS. 5 and 6, in response to driving of the power distributor 13, the power transmission member 135 may be supplied with power from the speed reducer 134. Accordingly the power transmission member 135 may move in a direction indicated with an arrow indicator of FIG. 5, and the second output terminal 132 may move in a direction approximately same as the direction indicated with the arrow indicator. The first output terminal 131 is connected to the second output terminal 132 through the connecting member 133. Thus, similar to the second output terminal 132, the first output terminal 131 may move in a direction approximately same as the direction indicated with the arrow indicator.

The connecting member 133 may include, for example, a single pair of parallel links configured to link the first output terminal 131 and the second output terminal 132. For example, the single pair of parallel links may have a parallelogram structure, According to such structure, the first output terminal 131 and the second output terminal 132 may slide relative to each other.

The protrusion 133a to which the second output terminal 132 is connected based on an RCM of the connecting member 133 may be disposed to be further away from the first output terminal 131. Accordingly, the second output terminal 132 may slide in the approximately same direction as that of the first output terminal 131 at a speed faster than that of the first output terminal 131. In this case, the first output terminal 131 may perform a translation upward relative to the proximal support 10 and the second output terminal 132 may perform a translation upward relative to the first output terminal 131.

Referring to FIGS. 5 and 6, in response to the power transmission member 135 moving upward, the first output terminal 131 may move upward and may make a motion shaft (e.g., the second shaft A2) of the subtalar joint move upward. The second output terminal 132 may move upward at a speed faster than that of the first output terminal 131. Accordingly, the second output terminal 132 may make the rotating frame 15 connected to the first output terminal 131 rotate counterclockwise based on FIG. 6. In this case, the motion assistance apparatus 1 may enable the ankle of the user to perform a dorsi-flexion motion.

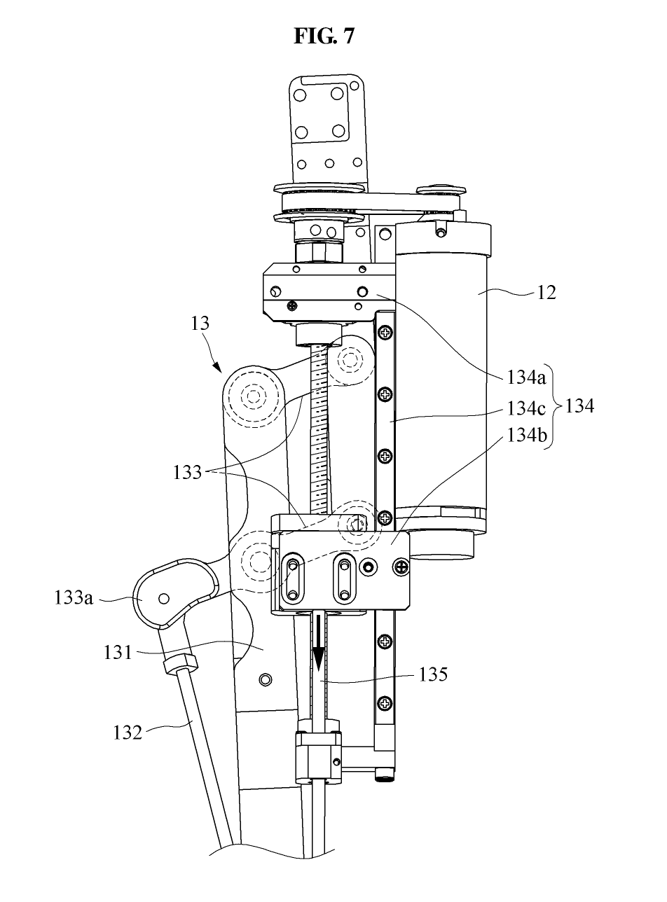

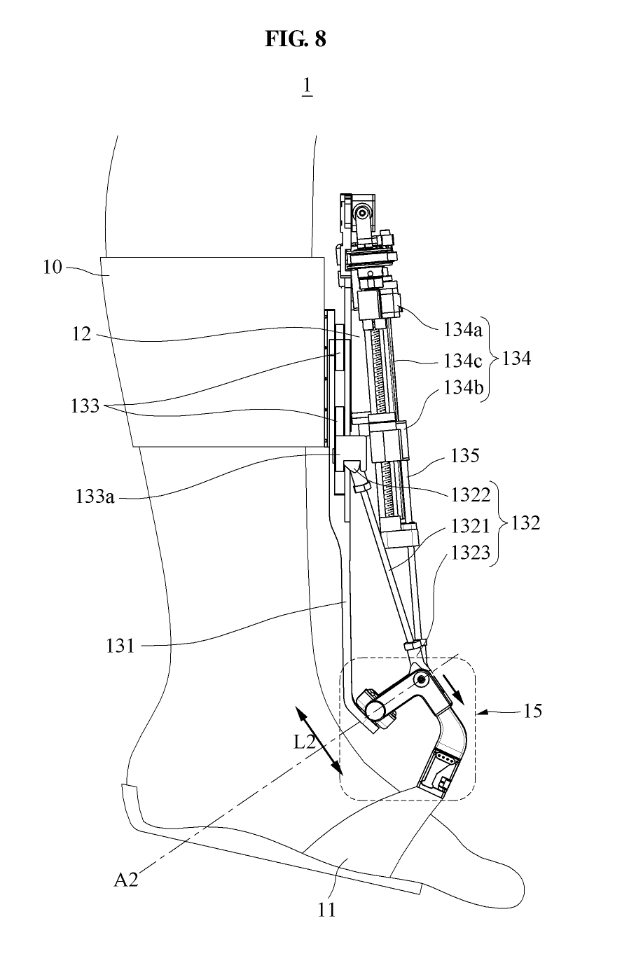

FIG. 7 is a front view of a power distributor according to at least one example embodiment when a talocrural joint of a user is in a plantar-flexion state. FIG. 8 is a side view of a motion assistance apparatus according to at least one example embodiment when a talocrural joint of a user is in a plantar-flexion state.

Referring to FIGS. 7 and 8, in response to the power transmission member 135 moving downward as indicated with an arrow indicator of FIG. 7, the first output terminal 131 may move downward and may make a motion shaft (e.g., the second shaft A2) of the subtalar joint move downward. The second output terminal 132 may move downward at a speed faster than that of the first output terminal 131, Accordingly, the second output terminal 132 may make the rotating frame 15 connected to the first output terminal 131 rotate clockwise based on FIG. 7. That is, the motion assistance apparatus 1 may enable the ankle of the user to perform a plantar-flexion motion.

In response to the ankle of the user switching from a dorsi-flexion state to a plantar-flexion state, the skin adjacent to the ankle of the user may be stretched. Even in this case, the distal support 11 may simultaneously or concurrently perform the translation and the rotation according to a structure of the rotating frame 15, which will be described below. Accordingly, the distal support 11 may maintain a relative location with respect to the foot of the user. Thus, for example, a skin rash due to an extension and/or a flexion of the ankle of the user may be prevented from occurring.

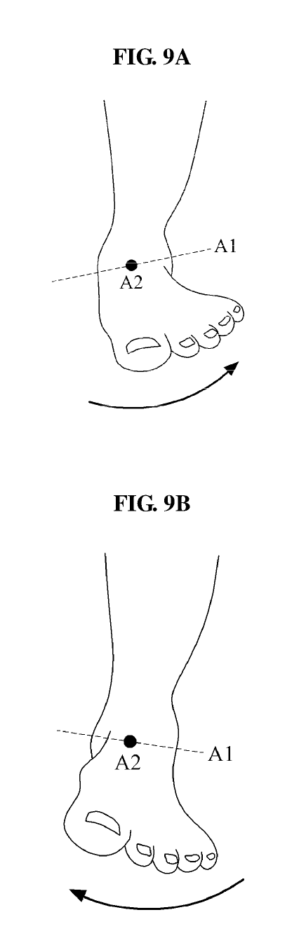

FIG. 9A illustrates an eversion motion of an ankle of a user. FIG. 9B illustrates an inversion motion of an ankle of a user.

Referring to FIGS. 9A and 9B, the ankle of the user may perform an eversion motion of bending outward and an inversion motion of bending inward based on the center of the user. A rotating shaft (e.g., the first shaft A1) of a dorsi-flexion motion and a plantar-flexion motion of the talocrural joint may vary in response to the above motions. In some example embodiment, referring to FIG. 9A, in response to the eversion motion of the ankle, the rotating shaft (e.g., the first shaft A1), of the talocrural joint may change to be downwardly oblique toward the center of the user. Referring to FIG. 9B, in response to the inversion motion of the ankle, the rotating shaft (e.g., the first shaft A1) of the talocrural joint changes to be upwardly oblique toward the center of the user. In some example embodiments, a slope of the rotating shaft (e.g., the first shaft A1) of the talocrural joint may be changed in response to the above eversion/inversion motion.

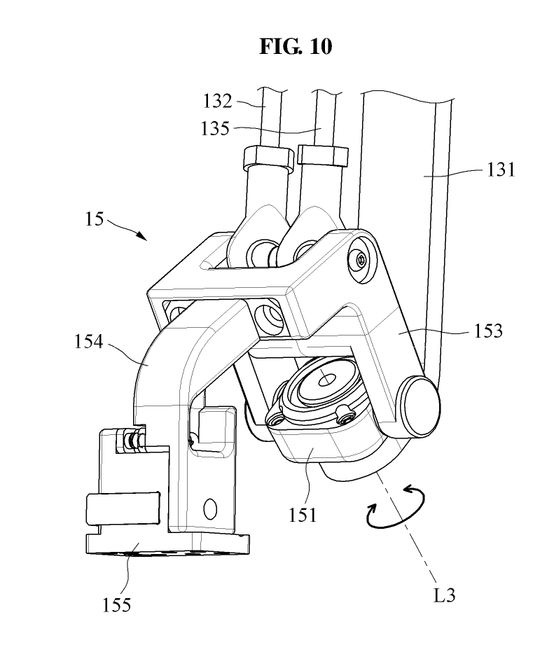

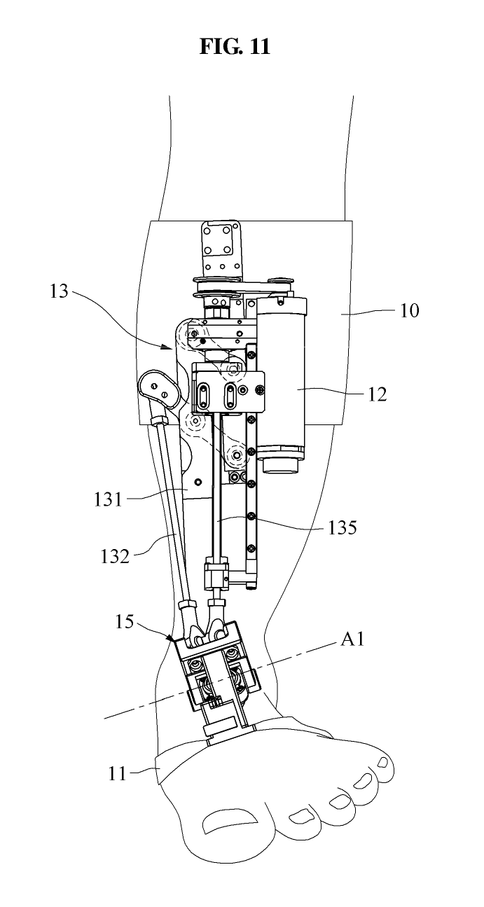

FIG. 10 is a partially enlarged view of a rotating frame according to at least one example embodiment. FIG. 11 is a front view of a motion assistance apparatus according to at least one example embodiment in an eversion state.

Referring to FIGS. 10 and 11, the rotating frame 15 may include a base link 151, a connection link 153, and a support link 154.

The base link 151 may be rotatably connected to the first output terminal 131 to be capable of following a movement of the subtalar joint. The base link 151 may be rotatably connected to the first output terminal 131 in a yaw-direction indicated with an arrow indicator of FIG. 10. That is, the base link 151 may rotate about a rotating shaft L3 that extends forward and upward from the ankle of the user. In response to the ankle of the user performing an eversion motion, the rotating frame 15 may rotate in a yaw direction relative to the first output terminal 131 by way of the base link 151. Accordingly, the motion assistance apparatus 1 may operate to adapt to a movement of the subtalar joint. The same description may be applicable to a case in which the ankle of the user performs an inversion motion. Thus, a further description is omitted here.

The support link 154 may be connected to the distal support 11 and may rotate in a pitch direction relative to the base link 151. The support link 154 may rotate on the plane that includes an extension line extending along a longitudinal direction of the foot and the rotating shaft L3 of the base link 151. Accordingly, although the rotating frame 15 is in a yaw-rotated state as shown in FIG. 11, the support link 154 may operate according to driving of the power transmission member 135 and the second output terminal 132, and the ankle of the user may freely move with 2 DOF.

The support link 154 may be connected to the base link 151 by way of the connection link 153, which is rotatably connected to the base link 151, instead of being directly connected to the base link 151. That is, the rotating frame 15 may include the connection link 153 connected between the base link 151 and the support link 154.

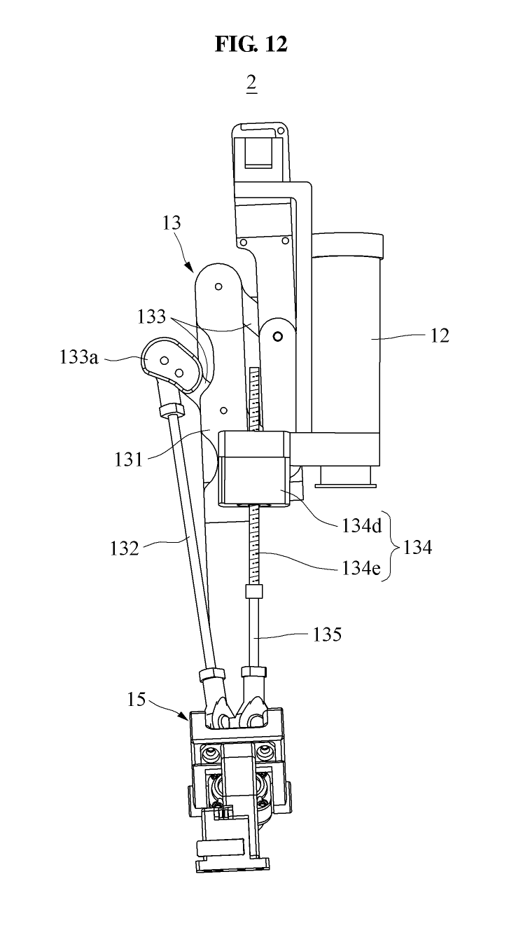

FIG. 12 is a front view of a motion assistance apparatus according to at least one example embodiment.

Referring to FIG. 12, a motion assistance apparatus 2 may include the driving source 12, the power distributor 13, and the rotating frame 15.

The power distributor 13 may include the speed reducer 134, the power transmission member 135, the first output terminal 131, the second output terminal 132, and the connecting member 133.

The speed reducer 134 may include a transmission mechanism (e.g., a ball screw) configured to convert a rotation to, for example, a translation. The speed reducer 134 may include a rotating member 134d configured to receive the rotation from the driving source 12, and a rotating shaft 134e configured to couple with the rotating member 134d.

The driving source 12 may make the rotating member 134d rotate clockwise or counterclockwise, and may make the rotating shaft 134e move upward and downward. For example, the rotating member 134d may include a female screw thread, and the rotating shaft 134e may include a male screw thread corresponding to the female screw thread. The rotating shaft 134e may be connected to the power transmission member 135, or may perform a rigid body motion with the power transmission member 135.

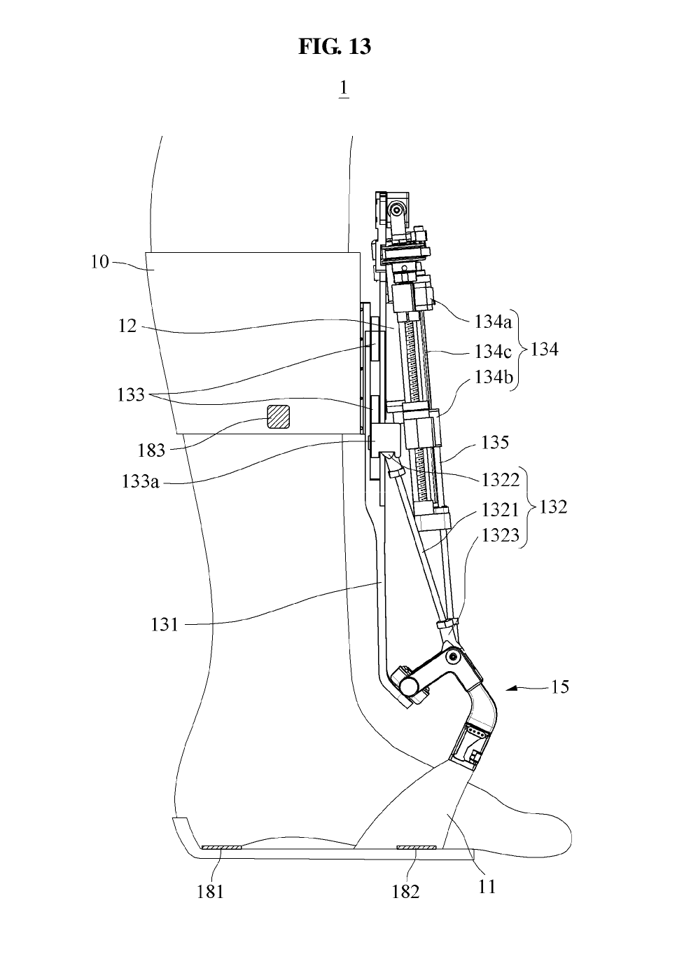

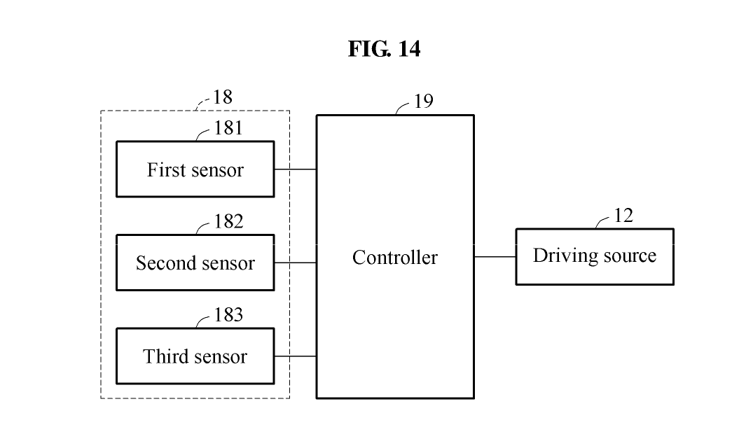

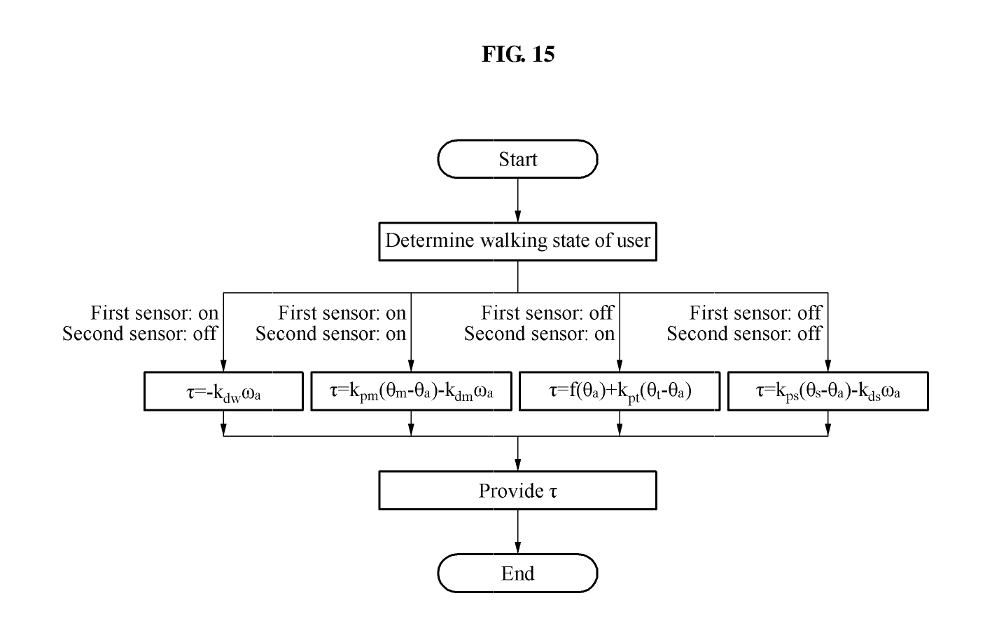

FIG. 13 is a side view of a motion assistance apparatus according to at least one example embodiment. FIG. 14 is a block diagram illustrating a motion assistance apparatus according to at least one example embodiment. FIG. 15 is a flowchart illustrating a controlling method of a motion assistance apparatus according to at least one example embodiment.

Referring to FIGS. 13 through 15, the motion assistance apparatus 1 may include the driving source 12 configured to generate a power for driving the rotating frame 15, a sensors 18 including pressure sensors provided to the distal support 11 and configured to measure a pressure of a distal portion of the user against the distal support 11, and a controller 19 configured to control the driving source 12 based on information measured at the sensors 18.

The sensors 18 may include a first sensor 181 configured to sense a pressure of a first part of the user, a second sensor 182 configured to sense a pressure of a second part of the user. The sensors 18 may include a third sensor 183 configured to measure an angle of the talocrural joint of the user. For example, the first sensor 181 may be provided at a location at which a heel of the user is to be placed in the distal support 11, the second sensor 182 may be provided at a location at which a metatarsal bone of the user is to be placed in the distal support 11, and the third sensor 183 may be provided on one side of the motion assistance apparatus 1. For example, each of the first sensor 181, the second sensor 182, and the third sensor 183 may be activated in response to detection of the pressure and may transmit a signal to the controller 19, and may be inactivated in response to no-detection of the pressure.

The controller 19 may determine a walking state of the user based on information of the sensors 18. The controller 19 may classify the walking state of the user into a plurality of phases by determining whether the pressure is sensed at the first sensor 181 and/or the second sensor 182. The controller 19 may control the driving source 12 based on a control signal corresponding to each of the phases.

If the pressure is sensed at the first sensor 181 and is not sensed at the second sensor 182, the controller 19 may determine the walking state of the user as a weight load phase. If the pressure is sensed at both of the first sensor 181 and the second sensor 182, the controller 19 may determine the walking state of the user as an intermediate phase. If the pressure is not sensed at the first sensor 181 and sensed at the second sensor 182, the controller 19 may determine the walking state of the user as a terminal phase. If the pressure is detected at none of the first sensor 181 and the second sensor 182, the controller 19 may determine the walking state of the user as a swing phase.

In some example embodiment, the weight load phase may correspond to an early stage of a standing phase and may be a stage in which the heel is in contact with the ground. The intermediate phase may correspond to a middle stage of the standing phase and may be a stage in which substantially an entire surface of the foot is in contact with the ground. The terminal phase may correspond to an end stage of the standing phase and may be a stage in which the forefoot is in contact with the ground and performs a push-off motion. The swing phase may be a phase in which the foot of the user performs a swing.

When the walking state of the user is determined as the weight load phase, the controller 19 may control the driving source 12 to supply the power in proportion to the angular velocity of the talocrural joint of the user. For example, an output torque τ provided from the driving source 12 may be expressed as Equation 1.

τ=−k_{dw}ωₐ [Equation 1]

In Equation 1, k_{dw} denotes a damping gain in the weight load phase, and ωₐ denotes the angular velocity of the talocrural joint of the user. The driving source 12 may provide, for example, the torque of Equation 1, to be capable of absorbing an impact transferred to the talocrural joint of the user when the heel of the user is in contact with the ground.

When the walking state of the user is determined as the intermediate phase, the controller 19 may control the driving source 12 to supply the power based on a difference between an angle of the talocrural joint of the user and a first setting angle and the angular velocity of the talocrural joint. The first setting angle may be an angle of the talocrural joint at a moment at which the walking state of the user changes from the weight load phase to the intermediate phase. For example, the torque r provided from the driving source 12 may be expressed as Equation 2.

τ=kₚₘ(θₘ−θₐ)−k_{dm}ωₐ [Equation 2]

In Equation 2, kₚₘ denotes a proportional gain in the intermediate phase, k_{dm} denotes a derivative gain in the intermediate phase, θₐ denotes a current angle of the talocrural joint, and θₘ denotes an angle of the talocrural joint at a moment at which the walking state of the user changes from the weight load phase to the intermediate phase. For example, according to an increase in a stride of the user, θₘ may decrease. For example, the driving source 12 may provide the torque of Equation 1, thereby preventing the user from falling forward.

When the walking state of the user is determined as the terminal phase, the controller 19 may control the driving source 12 to supply the power based on the angle of the talocrural joint of the user. For example, the torque τ provided from the driving source 12 may be expressed as Equation 3.

τ=f(θₐ)+kₚₜ(θₜ−θₐ) [Equation 3]

In Equation 3, f(θₐ) is a talocrural joint dependent torque and may be a torque similar to a torque profile of a normal walking. As described above, kₚₜ denotes a proportional gain in the terminal phase, and θₜ denotes an angle of the talocrural joint at which the walking state of the user changes from the terminal phase to the swing phase. For example, the driving source 12 may provide the torque of Equation 3, thereby assisting the push-off motion of the user.

When the walking state of the user is determined as the swing phase, the controller 19 may control the driving source 12 to supply the power based on a difference between the angle of the talocrural joint of the user and a second setting angle and the angular velocity of the talocrural joint. The second setting angle may be a maximum angle of the talocrural joint that allows the foot of the user not to fall over the ground in the swing phase. For example, a torque τ provided from the driving source 12 may be expressed as Equation 4.

τ=kₚₛ(θₛ−θₐ)−k_{ds}ωₐ [Equation 4]

In Equation 4, kₚₛ denotes a proportional gain in the swing phase, k_{ds} denotes a derivative gain in the swing phase, θₐ denotes a current angle of the talocrural joint, and θₛ denotes a maximum angle of the talocrural joint that allows the foot of the user not to fall over the ground in the swing phase. According to the controlling method illustrated in FIG. 15, it is possible to prevent the user who is experiencing trouble of lifting his or her ankle due to a knee injury, common peroneal nerve, or the like from walking with the foot being dragged on the ground in the swing phase by a foot drop phenomenon. For example, when the user is to apply a force for dorsi-flexion of the talocrural joint, the driving source 12 may provide a reaction force against the force for the dorsi-flexion. The user may adjust a magnitude of the reaction force by adjusting the proportional gain in the swing phase.

Example embodiments of the inventive concepts having thus been described, it will be obvious that the same may be varied in many ways. Such variations are not to be regarded as a departure from the intended spirit and scope of example embodiments of the inventive concepts, and all such modifications as would be obvious to one skilled in the art are intended to be included within the scope of the following claims.

What is claimed is:

1. A motion assistance apparatus comprising:
a proximal support configured to support a proximal part of a user;
a distal support configured to support a distal part of the user;
a rotating frame configured to connect to the distal support and perform a translation and a rotation relative to the proximal support;
a driving source configured to generate a rotational power; and
a speed reducer configured to convert the rotational power generated from the driving source to a translational power, and transfer the translational power to the rotating frame.

2. The motion assistance apparatus of claim 1, wherein the proximal support is configured to support a calf of the user and the distal support is configured to support a foot of the user, and
the rotating frame is in front of and above an ankle of the user in a state in which the motion assistance apparatus is worn by the user.

3. The motion assistance apparatus of claim 1, wherein the proximal support is configured to support a calf of the user and the distal support is configured to support a foot of the user, and
a portion of the rotating frame that is connected to the distal support is between an ankle and a forefoot of the user in a state in which the motion assistance apparatus is worn by the user.

4. The motion assistance apparatus of claim 1, further comprising:
a power distributor including a power transmission member, a first output terminal, and a second output terminal, the power transmission member configured to connect to the speed reducer and the rotating frame, the first output terminal and the second output terminal connected to the rotating frame and having different translation speeds relative to the proximal support.

5. The motion assistance apparatus of claim 4, wherein the power distributor further includes a connecting member configured to connect the first output terminal and the second output terminal, the connecting member configured to rotatably connect to the proximal support.

6. The motion assistance apparatus of claim 5, wherein the second output terminal includes:
a load body;
a first joint at a first end of the load body and configured to rotatably connect to the connecting member with at least 2 degrees of freedom (DOF); and
a second joint at a second end of the load body and configured to rotatably connect to the rotating frame with at least 2 DOF.

7. The motion assistance apparatus of claim 5, wherein in response to driving of the power distributor, the first output terminal is configured to perform the translation relative to the proximal part, and
the second output terminal is configured to perform the translation relative to the first output terminal.

8. The motion assistance apparatus of claim 7, wherein the connecting member includes a single pair of parallel links each configured to connect the first output terminal and the second output terminal.

9. The motion assistance apparatus of claim 4, wherein the rotating frame includes a base link, the base link configured to rotate in a yaw direction relative to the first output terminal.

10. The motion assistance apparatus of claim 9, wherein the base link is connected to the first output terminal, and the base link is configured to rotate about a rotation shaft, the rotation shaft extending forward and upward from an ankle of the user, and receive a movement occurring in response to a foot of the user performing an eversion and inversion motion based on a subtalar joint of the user.

11. The motion assistance apparatus of claim 9, wherein the rotating frame includes a support link, the support link configured to connect to the distal support and rotate in a pitch direction relative to the base link.

12. A motion assistance apparatus comprising:
a proximal support to be placed below a knee of a user;
a distal support to be place at a foot of the user;
a rotating frame between the proximal support and the distal support, the rotating frame configured to move with 2 degrees of freedom (DOF), receive a movement occurring in response to the foot performing a dorsi-and-plantar-flexion motion based on an talocrural joint of the user, and perform an eversion and inversion motion based on a subtalar joint of the user;
a pressure sensor at the distal support, the pressure sensor configured to measure a pressure of a distal part of the user against the distal support; and
a controller configured to control a driving source based on information measured at the pressure sensor.

13. The motion assistance apparatus of claim 12, wherein the pressure sensor includes:
a first sensor configured to sense a pressure of a first part of the foot of the user; and
a second sensor configured to sense a pressure of a second part of the foot of the user.

14. The motion assistance apparatus of claim 13, wherein the first sensor is at a location at which a heel of the user is to be placed in the distal support, and
the second sensor is at a location at which a metatarsal bone of the user is to be placed in the distal support.

15. The motion assistance apparatus of claim 13, wherein the controller is configured to classify a walking state of the user into a plurality of phases based on sensing signals of the first sensor and the second sensor, and control the driving source based on a control signal corresponding to each of the phases.

16. The motion assistance apparatus of claim 15, wherein further comprising:
a third sensor configured to measure an angle of the talocrural joint of the user, wherein the controller is configured to classify the walking state of the user into,
a weight load phase in a case that a pressure is sensed at the first sensor and is not sensed at the second sensor,
an intermediate phase in a case that the pressure is sensed at the first sensor and the second sensor,
a terminal phase in a case that the pressure is not sensed at the first sensor and is sensed at the second sensor, and
a swing phase in a case that the pressure is not sensed at the first sensor and the second sensor.

17. The motion assistance apparatus of claim 16, wherein the driving source is configured to supply a power in proportion to an angular velocity of the talocrural joint in the weight load phase.

18. The motion assistance apparatus of claim 16, wherein, the driving source is configured to supply a power based on a difference between the angle of the talocrural joint and a first setting angle and an angular velocity of the talocrural joint in the intermediate phase.

19. The motion assistance apparatus of claim 16, wherein the driving source is configured to supply a power based on the angle of the talocrural joint in the terminal phase.

20. The motion assistance apparatus of claim 16, wherein the driving source is configured to supply a power based on a difference between the angle of the talocrural joint and a second setting angle and an angular velocity of the talocrural joint in the swing phase.
